(19) United States
(12) Patent Application Publication
(10) Pub. No.: US 2007/0037552 A1
(43) Pub. Date: Feb. 15, 2007

(54) Method and system for performing two factor mutual authentication

(76) Inventors: Timothy Lee, San Mateo, CA (US); Christian Aabye, Foster City, CA (US); Douglas Fisher, Mountain View, CA (US)

Correspondence Address: Pepper Hamilton LLP;One Mellon Center, 50th Floor, 500 Grant Street, Pittsburgh, PA, 15219, US

(21) Appl. No.: 11/201,554

(22) Filed: Aug. 11, 2005

(51) Int. Cl. H04M 3/16

(52) U.S. Cl. 455/410

(57) ABSTRACT

A method and system for performing a secure transaction are disclosed. A service provider system may receive an account identifier and a one-time passcode from a user system via a communication network. The service provider system may determine whether the one-time passcode is valid. If the one-time passcode is valid, the service provider system may transmit a personal assurance message to the user system via the communication network. If the personal assurance message is verified, the service provider may receive a password from the user system via the communication network and determine whether the password is valid. If the password is valid, the user system and the service provider system may then perform a secure transaction.

### BACKGROUND

Technological improvements have allowed businesses and individuals to engage in transactions in new and expanding environments. For example, computer networks, such as the Internet and/or wireless networks, have enabled the exchange of information, such as in financial transactions, to be performed using any electronic device that can communicate information over a computer network.

With respect to financial transactions, consumers appreciate the convenience of performing such transactions without having to visit a service provider directly. Accordingly, consumers can avoid the time spent driving to, for example, a retail location, a doctor's office, a bank and/or the like and the hassle associated with, for example, shopping in a retail environment or waiting in line at a bank or in a doctor's office by performing these transactions from the privacy of their own home.

Although the use of the Internet to perform transactions historically occurring in person has increased substantially, one of the primary factors hindering continued expansion is the potential security issues posed by performing such transactions in an online environment. Current systems for performing such transactions have inherent weaknesses in their security protocols. For example, such systems often use static passcodes. An unauthorized third party may obtain the static passcode by intercepting an electronic transaction and reverse engineering the transaction's data to determine the account information and the passcode contained within.

Moreover, the user may access a service provider that cannot be authenticated. For example, an Internet user intending to access a service provider's Web site may have data re-directed through, or may unintentionally directly access, an unauthorized Web site that extracts information for the purpose of subsequently committing fraud. As such, the consumer may desire to authenticate the Web site that is being accessed prior to providing sensitive or confidential information.

Accordingly, consumers and organizations have concerns regarding the possibility that a transaction performed in an online environment could permit information to be taken without the consumer's authorization. What is needed is a method and system for inhibiting unauthorized accesses to online transactions.

A need exists for a method and system that permits an online transaction to be performed securely.

A need exists for a method and system that permits a user to verify the authenticity of a particular location on the Internet such as the user's bank or desired merchant, before sending sensitive or confidential information to that location.

A further need exists for a method and system of performing two-factor mutual authentication between a user system and a host system to inhibit fraudulent access to online transactions.

The present disclosure is directed to solving one or more of the above-listed problems.

### SUMMARY

Before the present methods, systems and materials are described, it is to be understood that this invention is not limited to the particular methodologies, systems and materials described, as these may vary. It is also to be understood that the terminology used in the description is for the purpose of describing the particular versions or embodiments only, and is not intended to limit the scope of the invention which will be limited only by the appended claims.

It must also be noted that as used herein and in the appended claims, the singular forms “a,” “an,” and “the” include plural references unless the context clearly dictates otherwise. Thus, for example, reference to a “user” is a reference to one or more of the parties or locations involved in any exchanges of value, data and/or information. Unless expressly stated otherwise, all undefined technical and scientific terms used herein have the same meanings as commonly understood by one of ordinary skill in the art, while all defined technical and scientific terms shall be deemed to include the same meaning as commonly understood by one of ordinary skill in the art with the stated definition. Although any methods, materials, and devices similar or equivalent to those described herein can be used, the preferred methods, materials, and devices are now described. All publications mentioned herein are incorporated by reference. Nothing herein is to be construed as an admission that the invention is not entitled to antedate such disclosure by virtue of prior invention.

In an embodiment, a method for performing a secure transaction over a communication network may include receiving an account identifier and a one-time passcode from a user system via a communication network, determining whether the one-time passcode is valid, transmitting a personal assurance message to the user system via the communication network if the one-time passcode is valid. The personal assurance message is information known to the user that enables the user to verify the authenticating of the site. If the user confirms the personal assurance message, a password is received from the user system via the communication network, a determination of whether the password is valid is performed, and a secure transaction is performed if the password is valid.

In an embodiment, a system for performing a secure transaction may include a user system, a communication network in operable communication with the user system, and a service provider system in operable communication with the communication network. The user system may transmit an account identifier and a one-time passcode to the service provider system via the communication network. The service provider system may determine whether the one-time passcode is valid and may transmit a personal assurance message to the user system via the communication network if the one-time passcode is valid. The user system may determine whether the personal assurance message is valid and may transmit a password to the service provider system via the communication network if the personal assurance message is valid. The service provider system may determine whether the password is valid. If the password is valid, the user system and the service provider system may perform a transaction via the communication network.

### BRIEF DESCRIPTION OF THE DRAWINGS

Aspects, features, benefits and advantages of the embodiments of the present invention will be apparent with regard to the following description, appended claims and accompanying drawings where:

FIG. 1 depicts a flow diagram of an exemplary method for performing a secure e-commerce transaction over a communication network according to an embodiment.

FIG. 2 depicts a flow diagram of an exemplary method for performing a secure financial transaction over a communication network according to an embodiment.

FIG. 3 depicts a flow diagram of an exemplary method for performing a secure healthcare transaction over a communication network according to an embodiment.

FIG. 4 depicts an exemplary system for performing a secure transaction according to an embodiment.

### DETAILED DESCRIPTION

Two-factor mutual authentication may use, for example, a one-time passcode and a personal assurance message to allow each party to a transaction to verify the other party. For example, a user may submit a one-time passcode to initiate the formation of a secure transaction connection. The passcode may be verifiable by the receiver to ensure that the user has access to a one-time passcode generator. If verified, the receiver may transmit a personal assurance message to the user. The personal assurance message may permit the user to verify that the receiver is authentic. In this manner, each party to a remote transaction may verify that the other party is identifiable.

A transaction may be, for example, any exchange of data performed with respect to e-commerce, online banking, health care provision and/or any similar data exchange. The transaction may result in the transfer of money, loyalty points and/or other units of commerce from one party to another in exchange for a corresponding good or service. Alternately, the transaction may result in the transfer of funds from one account to another account in one or more banking systems. The transaction may result in the transfer of health care information or services to a particular individual. Likewise, other transactions may result in the transfer of similar types of data, money, goods and/or services.

A transaction, such as an e-commerce, online banking, healthcare and/or other transaction, may be initiated by using, for example, account information. The account information may be an account number and/or account holder for a credit card, a debit card, a smart card, a stored value card, an ATM card, a bank account, or an insurance plan and/or any other alphanumeric identifier. The transaction may also include a one-time passcode, which may be generated by the transaction card and/or a related device.

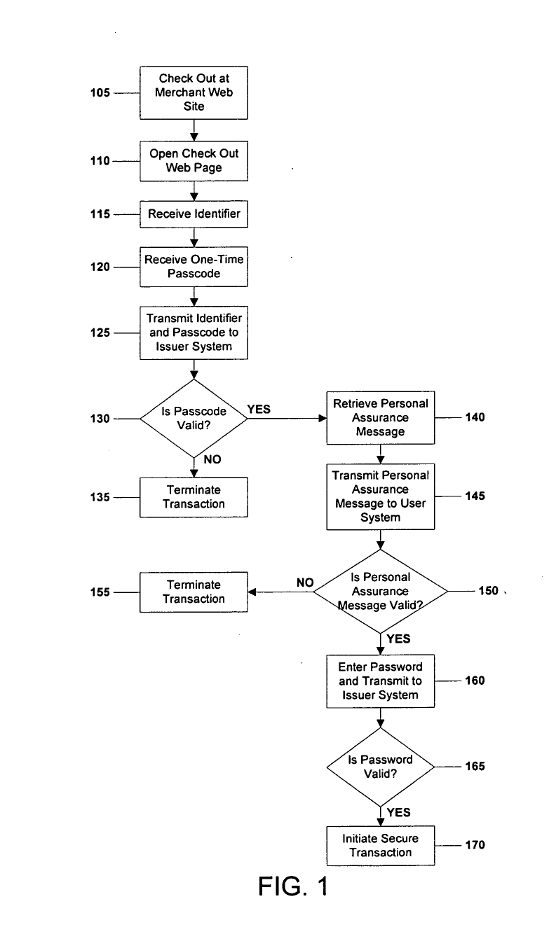

FIG. 1 depicts a flow diagram of an exemplary method for performing a secure e-commerce transaction over a communication network according to an embodiment. Prior to the steps shown in FIG. 1, a user may browse a merchant Web site for goods and/or services. Upon selection of the goods and/or services for purchase, the user may initiate a transaction by checking out 105 at the merchant Web site. For example, the user may select a “purchase” or “checkout” button provided by the merchant Web site. Checkout may include the selection of a mode of payment by the user, a confirmation of purchased items, an identification of shipping and/or billing addresses, and/or other similar requests for information. When the user selects a transaction card as the mode of payment, a checkout web page 110, for example, may be accessed for purposes of initiating a secure payment. Preferably, the checkout web page 110 may be controlled entirely by the issuer of the transaction card thereby allowing the user to interface directly with the issuer in order to eliminate the possibility of security breaches occurring in the exchange of data with the merchant.

At the initial checkout page, the user may be prompted to enter 115 an account number. In an embodiment, the account number may include a credit card account number, a debit card account number, a stored value card account number, a financial account number and/or a similar account number. The account number may be, without limitation, an alphanumeric identifier denoting a particular account and/or a particular user, or any other alphanumeric identifier.

The user may also be prompted to enter 120 a one-time passcode. In an embodiment, the one-time passcode may be generated by a one-time passcode generator, such as a powered transaction card and/or a similar device with a microprocessor capable of generating a passcode in accordance with agreed upon protocols. The one-time passcode may change on a periodic basis, such as every minute, hour or the like.

In an embodiment, the one-time passcode may be computed using a timestamp. In an alternate embodiment, the one-time passcode may be computed based on a number of successfully completed transactions that have previously been performed using the transaction card. Additional methods of computing the one-time passcode may also be used within the scope of this disclosure and will be apparent to those of ordinary skill in the art.

In an embodiment, the one-time passcode may be a seemingly random alphanumeric identifier that is computed according to an algorithm implemented in the one-time passcode generator. In each such embodiment, the one-time passcode may be generated in a manner that is known to the issuer.

In an embodiment, the one-time passcode generator may communicate the one-time passcode to the user via an output device. For example, the one-time passcode may be displayed on a screen and/or announced through a speaker to inform the user of the one-time passcode.

The one-time passcode may be entered 120 using a user system for performing the e-commerce transaction. In an embodiment, the user may enter the one-time passcode via a user interface. In an alternate embodiment, the one-time passcode may be entered using electronic means, such as a data port connected to the user system. In such an embodiment, the one-time passcode may not be displayed and/or announced to the user and/or the one-time passcode generator may not have a display and/or a speaker.

The account number and the one-time passcode may then be transmitted 125, either together or separately, to the issuer system over a communication network. In an embodiment, the communication network may be the Internet, an intranet, and/or the like. In an embodiment, the transmission may be made over a secure network connection. In an alternate embodiment, the transmission may be made over a non-secure network connection.

The one-time passcode received at the issuer system from the user will then be compared 130 to a passcode independently generated at the issuer system. The issuer may utilize substantially similar protocols for generating the issuer-generated passcode as utilized by the device. For example, the issuer system may determine the algorithm used to produce the one-time passcode based on, for example, the account number. Alternatively, the algorithm may be agreed upon in advance by the user and the issuer system. In an embodiment, the received one-time passcode may be verified 130 by comparing it with an expected passcode value for the current time frame and one or more passcode values for previous time frames. Such an embodiment may allow the issuer to verify 130 the received one-time passcode even if the expected value of the one-time passcode changes during the course of the transaction. If the passcode received from the user is not verified, the issuer system, for example, may terminate 135 the transaction as the user has not been authenticated to the issuer.

If the passcode received from the user is verified, the account number may be used to retrieve 140 a personal assurance message stored at the issuer system. The personal assurance message may include, for example, a digital image, a video stream, an alphanumeric sequence, a sound file, and/or the like. The user may provide the personal assurance message to the issuer prior to the transaction, such as at a time when the account is formed.

The personal assurance message may be transmitted 145 to the user system, which may permit the user to view, hear and/or otherwise comprehend the personal assurance message. The user may then determine 150 whether the personal assurance message is correct. If the personal assurance message is incorrect, the user may recognize 155 that the purchase Web site is not authentic and/or the transaction has been compromised. Accordingly, the user may terminate the transaction prior to entering sensitive or confidential information. Importantly, by terminating the transaction at this stage, the user may be protected against the fraudulent use of the user's account since the password, which permits use of the account, has not yet been entered and since the one-time passcode is not usable for future transactions.

If the personal assurance message is correct, the user may enter 160 a password, which enables the account to be used for the particular transaction. The password may be transmitted to the issuer system. The issuer system may determine 165 whether the password is valid. If the password is valid, the user system and the issuer system may initiate 170 a secure transaction utilizing the particular account.

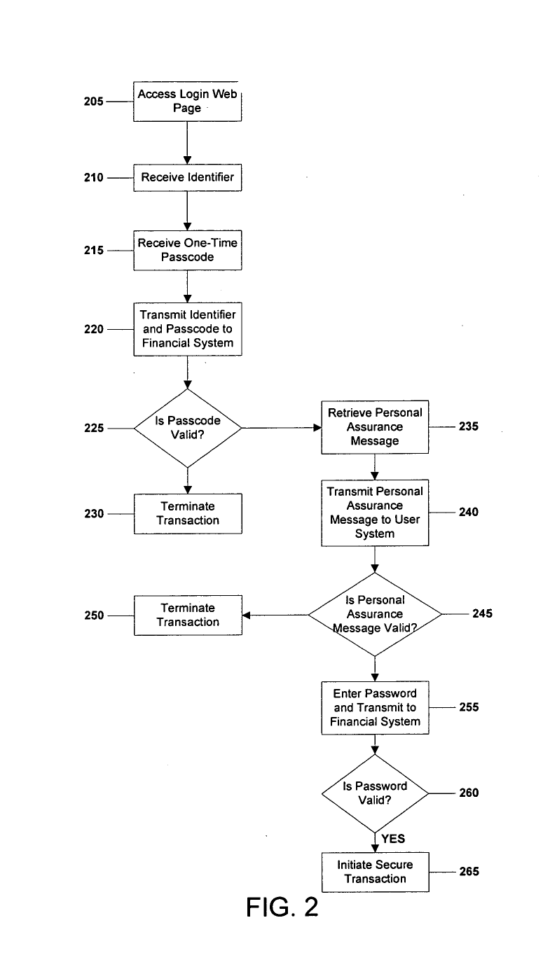

FIG. 2 depicts a flow diagram of an exemplary method for securely accessing a financial account, or other location, over a communication network according to an embodiment. For example, an embodiment may include a method for a user to access a financial institution's website in a manner that is both secure and that assures that the user's sensitive information is provided to the financial institution as opposed to a third party posing as the financial institution. The process may be initiated when the user accesses 205 a login Web page for the financial institution. A financial institution may include a bank, a brokerage, a security investment organization, and/or the like.

At the login web page, the user may be prompted to enter 210 an identifier. The identifier may include a user name, an account number and/or any other alphanumeric identifier.

The user may also be prompted to enter 215 a one-time passcode. In an embodiment, the one-time passcode may be generated by a one-time passcode generator, such as a powered transaction card and/or a similar device with a microprocessor capable of generating a passcode in accordance with agreed upon protocols. The one-time passcode may change on a periodic basis, such as every minute, hour or the like.

In an embodiment, the one-time passcode may be computed using a timestamp. In an alternate embodiment, the one-time passcode may be computed based on a number of successfully completed transactions that have previously been performed using the transaction card. Additional methods of computing the one-time passcode may also be used within the scope of this disclosure and will be apparent to those of ordinary skill in the art.

In an embodiment, the one-time passcode may be a seemingly random alphanumeric identifier that is computed according to an algorithm implemented in the one-time passcode generator. In each such embodiment, the one-time passcode may be generated in a manner that is known to the financial institution.

In an embodiment, the one-time passcode generator may communicate the one-time passcode to the user via an output device. For example, the one-time passcode may be displayed on a screen and/or announced through a speaker to inform the user of the one-time passcode.

The one-time passcode may be entered 215 using a user system for performing the transaction. In an embodiment, the user may enter the one-time passcode via a user interface. In an alternate embodiment, the one-time passcode may be entered using electronic means, such as a data port connected to the user system. In such an embodiment, the one-time passcode may not be displayed and/or announced to the user and/or the one-time passcode generator may not have a display and/or a speaker.

The account number and the one-time passcode may then be transmitted 220, either together or separately, to the financial institution system over a communication network. In an embodiment, the communication network may be the Internet, an intranet and/or the like. In an embodiment, the transmission may be made over a secure network connection. In an alternate embodiment, the transmission may be made over a non-secure network connection.

The one-time passcode received at the financial institution system from the user will then be compared 225 to a passcode independently generated by the financial institution system. In independently generating the passcode, the financial institution system may utilize substantially similar protocols for generating the passcode as utilized by the user. For example, the financial institution system may determine the algorithm used to produce the one-time passcode based on, for example, the identifier. Alternatively, the algorithm may be agreed upon in advance by the user and the financial institution system. In an embodiment, the received one-time passcode may be verified 225 by comparing it with an expected passcode value for the current time frame and one or more passcode values for previous time frames. Such an embodiment may allow the financial institution to verify 225 the received one-time passcode even if the expected value of the one-time passcode changes during the course of the transaction. If the passcode received from the user is not verified, the financial institution system, for example, may prohibit access to the financial institution's site 230.

If the passcode received from the user is verified, the identifier may be used to retrieve 235 a personal assurance message stored at the financial institution system. The personal assurance message may include, for example, a digital image, a video stream, an alphanumeric sequence, a sound file, and/or the like. The user may provide the personal assurance message to the financial institution prior to the transaction, such as at a time when the account is formed.

The personal assurance message may be transmitted 240 to the user system, which may permit the user to view, hear and/or otherwise comprehend the personal assurance message. The user may then determine 245 whether the personal assurance message is correct. If the personal assurance message is incorrect, the user may recognize 250 that the financial institution Web site is not authentic and/or the transaction has been compromised. Accordingly, the user may terminate the attempt to access the financial institution site prior to entering sensitive or confidential information. Importantly, by terminating the effort to access the financial institution site at this stage, the user may be protected against attempts to fraudulently obtain the needed information from the user to access the location since the user's password, which is necessary to gain such access, has not yet been entered, and since the one-time passcode is not usable for future attempts.

If the personal assurance message is correct, the user may enter 255 a password, which enables access to the user's account located on the financial institution system. The password may be transmitted to the financial institution system. The financial institution system may determine 260 whether the password is valid. If the password is valid, the user is permitted access to the financial institution system 265.

Although described with reference to a financial institution system, a person of ordinary skill in the art will understand that the above description will be equally applicable to any other type of service provider that may require restricted or secure access to their site.

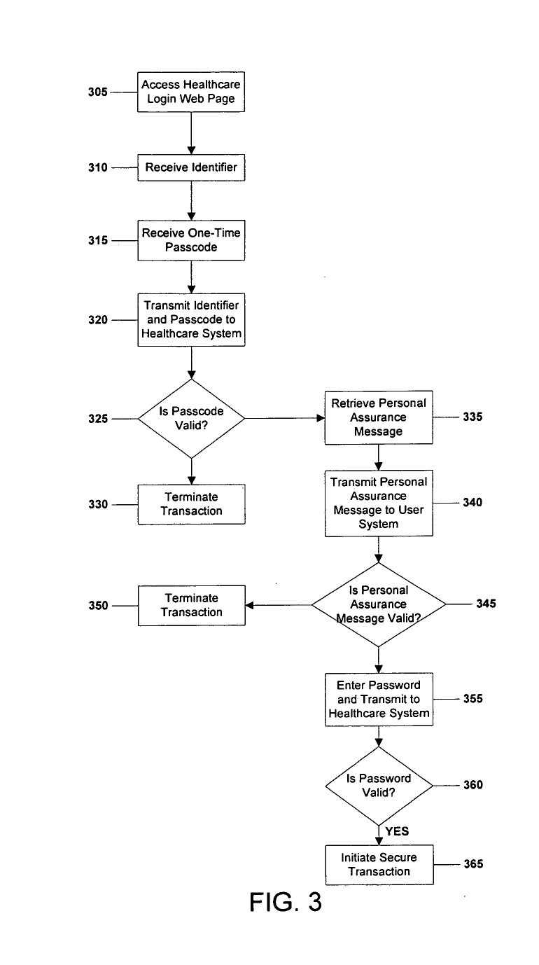

FIG. 3 depicts a flow diagram of an exemplary method for performing a secure healthcare transaction over a communication network according to an embodiment. The user may initiate a healthcare transaction by accessing 305 a login Web page for a healthcare provider. A healthcare provider may include a doctor's office, an insurance provider, a hospital, a clinic and/or the like.

At the login page, the user may be prompted to enter 310 an identifier. The identifier may include a user name, an account number and/or any other alphanumeric identifier.

The user may also be prompted to enter 315 a one-time passcode. In an embodiment, a one-time passcode generator, such as a powered transaction card and/or a similar device with a microprocessor capable of generating a passcode in accordance with agreed upon protocols, may determine the one-time passcode. The one-time passcode may change on a periodic basis, such as every minute, hour or the like.

In an embodiment, the one-time passcode may be computed using a timestamp. In an alternate embodiment, the passcode may be computed based on a number of successfully completed transactions that have previously been performed using the transaction card. Additional methods of computing the one-time passcode may also be used within the scope of this disclosure and will be apparent to those of ordinary skill in the art.

In an embodiment, the one-time passcode may be a seemingly random alphanumeric identifier that is computed according to an algorithm implemented in the one-time passcode generator. In each such embodiment, the passcode may be generated in a manner that is known to the healthcare provider.

In an embodiment, the one-time passcode generator may communicate the passcode to the user via an output device. For example, the one-time passcode may be displayed on a screen and/or announced through a speaker to inform the user of the passcode.

The one-time passcode may be entered 315 using a user system for performing the healthcare transaction. In an embodiment, the user may enter the one-time passcode via a user interface. In an alternate embodiment, the one-time passcode may be entered using electronic means, such as a data port connected to the user system. In such an embodiment, the one-time passcode may not be displayed and/or announced to the user and/or the one-time passcode generator may not have a display and/or a speaker.

The account number and the one-time passcode may then be transmitted 320, either together or separately, to the healthcare provider system over a communication network. In an embodiment, the communication network may be the Internet, an intranet and/or the like. In an embodiment, the transmission may be made over a secure network connection. In an alternate embodiment, the transmission may be made over a non-secure network connection.

The one-time passcode received at the healthcare provider system from the user will then be compared 325 to a passcode independently generated by the healthcare provider system. In independently generating the passcode, the healthcare provider system may utilize substantially similar protocols for generating the passcode as utilized by the user. For example, the healthcare provider system may determine the algorithm used to produce the one-time passcode based on, for example, the identifier. Alternatively, the algorithm may be agreed upon in advance by the user and the healthcare provider system. In an embodiment, the received one-time passcode may be verified 325 by comparing it with an expected passcode value for the current time frame and one or more passcode values for previous time frames. Such an embodiment may allow the healthcare provider to verify 325 the received one-time passcode even if the expected value of the one-time passcode changes during the course of the transaction. If the passcode is not verified, the healthcare provider system, for example, may terminate 330 the transaction.

If the passcode received from the user is verified, the identifier may be used to retrieve 335 a personal assurance message stored at the healthcare provider system. The personal assurance message may include, for example, a digital image, a video stream, an alphanumeric sequence, a sound file, and/or the like. The user may provide the personal assurance message to the healthcare provider prior to the transaction, such as at a time when the account is formed.

The personal assurance message may be transmitted 340 to the user system, which may permit the user to view, hear and/or otherwise comprehend the personal assurance message. The user may then determine 345 whether the personal assurance message is correct. If the personal assurance message is incorrect, the user may recognize 350 that the healthcare provider Web site is not authentic and/or the transaction has been compromised. Accordingly, the user may terminate the transaction prior to entering sensitive or confidential information. Importantly, by terminating the transaction at this stage, the user may be protected against attempts to fraudulently obtain the information needed to access the user's healthcare account and/or information since the user's password, which is necessary for such access, has not yet been entered and since the one-time passcode is not usable for future attempts.

If the personal assurance message is correct, the user may enter 355 a password which enables access to the healthcare provider system. The password may be transmitted to the healthcare provider system. The healthcare provider system may determine 360 whether the password is valid. If the password is valid, the user is permitted access to the healthcare provider system 365.

Additional and alternate embodiments using processes similar to the ones described above may be used in a variety of settings.

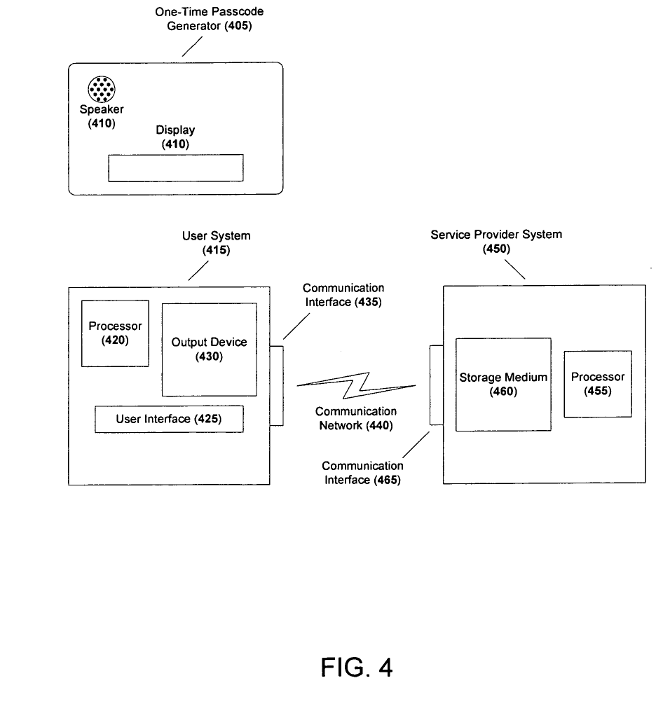

FIG. 4 depicts an exemplary system for performing a secure transaction according to an embodiment. As shown in FIG. 4, the system may include a one-time passcode generator 405, a user system 415, a communication network 440, and a service provider system 450.

The one-time passcode generator 405 may include, for example, a transaction card having a processor that implements an algorithm for computing a passcode. The computed passcode may be unique to a particular transaction. In an embodiment, the one-time passcode generator 405 may dynamically generate a passcode based on, for example, a timestamp and/or account information.

A passcode may alternately be retrieved from a list of one-time-use passcodes. In an embodiment, such passcodes may be used in a particular order so that the service provider system can verify a particular passcode. Other embodiments are envisioned and within the scope of the present disclosure.

The one-time passcode generator 405 may provide the passcode to a user via an output device 410, such as a display and/or a speaker. The user may then provide the passcode to the user system 415 via a user interface 425. Alternately or additionally, the one-time passcode generator 405 may directly provide the passcode to the user system 410 via an output data port (not shown).

The user system 415 may include a processor 420, a user interface 425, an output device 430, and a communication interface 435. The user interface 425 may include a keyboard, a mouse, a trackball, an/or any other input device for providing information to the processor 420 from a user. The output device 430 may include a display, one or more speakers or the like for providing information to the user. The communication interface 435 may permit communication between the user system 415 and the communication network 440. In an embodiment, the user system 415 may further include an input data port (not shown) for directly receiving information from the one-time passcode generator 405.

The communication network 440 may be a computer network, such as the Internet, an intranet and/or the like, for passing information between remote computer systems. The communication network 440 may be in operable communication with each of the user system 415 and the service provider system 450 via respective communication interfaces 435 and 465.

The service provider system 450 may include a processor 455, a storage medium 460, and a communication interface 465. The processor 455 may receive information from the communication network 440 via the communication interface 465. The received information may include account information and a passcode received from a user system 415. The processor 455 may compare the received passcode with an expected passcode to determine whether to authenticate the user supplying the passcode. If the user is authenticated, the processor 455 may retrieve a personal assurance message from the storage medium 460. The processor 455 may then transmit the personal assurance message to the user system 415 via the communication network 440.

Upon receipt, the processor 420 of the user system 415 or the user, via, for example, the user interface 425, may use the personal assurance message to authenticate the service provider system 450. If the service provider system 450 is authenticated, the user may enter a password into the user system 415 and begin the transaction.

It will be appreciated that various of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art.

What is claimed is:

1. A method for performing a secure transaction over a communication network, the method comprising:
receiving an account identifier and a one-time passcode from a user system via a communication network;
determining whether the one-time passcode is valid;
if the one-time passcode is valid, transmitting a personal assurance message to the user system via the communication network;
receiving a password from the user system via the communication network;
determining whether the password is valid; and
if the password is valid, performing a secure transaction.

2. The method of claim 1 wherein the account identifier comprises one or more of the following:
a credit card account number;
a name of a credit card account holder;
a debit card account number;
a name of a debit card account holder;
a bank account number;
a name of a bank account holder;
a brokerage account number;
a name of a brokerage account holder;
an insurance policy number; and
a name of an insurance policy holder.

3. The method of claim 1 wherein the account identifier comprises an alphanumeric identifier.

4. The method of claim 1 wherein the one-time passcode comprises a passcode generated based on at least a timestamp.

5. The method of claim 1 wherein the one-time passcode comprises a passcode generated based on at least a number of transactions that have previously been successfully completed using the financial account identifier.

6. The method of claim 1 wherein the one-time passcode comprises a passcode generated based on an algorithm designated prior to issuing the financial account identifier to a user.

7. The method of claim 1 wherein the one-time passcode comprises a passcode that is recomputed on a periodic basis.

8. The method of claim 1 wherein the one-time passcode comprises an alphanumeric identifier.

9. The method of claim 1 wherein the communication network comprises the Internet.

10. The method of claim 1 wherein determining whether the one-time passcode is valid comprises comparing the one-time passcode to a local passcode corresponding to the account identifier.

11. The method of claim 1 wherein the personal assurance message corresponds to the account identifier.

12. The method of claim 1 wherein determining whether the password is valid comprises comparing the password to a local password corresponding to the account identifier.

13. A system for performing a secure transaction, the system comprising:
a user system;
a communication network in operable communication with the user system; and
a service provider system in operable communication with the communication network,
wherein:
the user system transmits an account identifier and a one-time passcode to the service provider system via the communication network,
the service provider system determines whether the one-time passcode is valid,
if valid, the service provider system transmits a personal assurance message to the user system via the communication network,
the user system determines whether the personal assurance message is valid,
if valid, the user system transmits a password to the service provider system via the communication network,
the service provider system determines whether the password is valid, and
if valid, the user system and the service provider system perform a transaction via the communication network.

14. The system of claim 13 wherein the communication network comprises the Internet.

15. The system of claim 13 wherein determining whether the one-time passcode is valid comprises comparing the one-time passcode to a local passcode corresponding to the account identifier.

16. The system of claim 13 wherein determining whether the personal assurance message is valid comprises presenting the personal assurance message to a user of the user system.

17. The system of claim 13 wherein the personal assurance message corresponds to the account identifier.

18. The system of claim 13, further comprising:
a one-time passcode generator, wherein the one-time passcode generator generates the one-time passcode, and wherein the user system receives the one-time passcode.

19. The system of claim 18 wherein the one-time passcode generator comprises one or more of:
a screen for displaying the one-time passcode; and
a speaker for announcing the one-time passcode.

20. The system of claim 18 wherein the one-time passcode generator is in operable communication with the user system.
